(19) United States
(12) Patent Application Publication
(10) Pub. No.: US 2008/0192207 A1
(43) Pub. Date: Aug. 14, 2008

(54) Single and Double Immaterial Ellipsoid

(76) Inventor: Gwenole Bocquet, Belleville Sur Saone (FR)

Correspondence Address: Vern Maine & Associates, 100 MAIN STREET, P O BOX 3445, NASHUA, NH, 03061-3445, US

(21) Appl. No.: 11/909,327

(22) PCT Filed: Mar. 22, 2006
(86) PCT No.: PCT/FR2006/000619

§ 371 Date: Sep. 21, 2007

(30) Foreign Application Priority Data
Mar. 22, 2005 (FR) 0502795
Mar. 10, 2006 (FR) 0602120

(51) Int. Cl. G02B 27/22

(52) U.S. Cl. 353/38; 359/742

(57) ABSTRACT

An element generating through optical effect an “intangible” form (exempli gratia a sphere) detached from any support. The element comprises three Fresnel lenses that can be integrated in a luminary or in a device presenting objects in a three-dimensional perspective.

### FIELD OF THE INVENTION

The invention relates to an optical device generating a three-dimensional form detached of any support. The aforementioned form may be a sphere, an ellipsoid, a cylinder, a cone, a cube, a pyramid etc. This machine projects orthoscopic sources of light leaning on no material support and visible under natural lightning, without wearing any accessory. The invention allows information to be projected within the “intangible” form generated, which can apply to (non exhaustive list) luminaries, presentation of electroluminescent information, objects or video. It particularly relate to the projection of luminous sources, giving the impression that these sources are detached from any material sources and are floating in the air, within the “intangible” form generated by the machine.

### BACKGROUND OF THE INVENTION

The multiplication of projection screens has been witnessed for a couple of years, be it at cultural or artistic events, or during trade shows. The technology is globally always the same: these projection screens consist in video projectors or in flat screens put on walls. The images are hence bi-dimensional and flat, which sensibly reduces the visual impact. There are also solutions generating real images detached from any surrounding material source; there are nevertheless technical difficulties in the use of such processes to generate images on several square meters surface screens and with ‘good’ angles of vision. Patents on lenticular networks aimed at generating three-dimensional images are also known, but the use of such networks requires screens with a high resolution if we want to increase the number of possible points of view. Furthermore the vision angle is often limited, which can constitute a hindrance for observers. Generally this production of images without any material support is possible using an optical lens or a parabola combined with a semi-reflecting return, under a principle first described in a German patent dating from 1962. But even if this process is relatively old its commercial applications still remain practically inexistent because of the problems mentioned above. Almost all technical documents about three-dimensional images detached from their original support apply to video and rarely to objects, while the field of luminaries is almost never mentioned.

### SUMMARY OF THE INVENTION

The object of one embodiment of the present invention is to provide an optical device adapted to generate sources of light leaning on no material support (i.e. that are like floating in the air) which allows to partially or totally remove the disadvantages mentioned above. This “intangible” source of light results from the intersection of luminous beams generated by a projection screen based on the optical principle of refraction. These beams are indeed sources of light leaning on no physical material support since they are projected by the screen, at a distance called “projection distance” (distance between a given pixel and the screen).

More precisely here is a list of objects created based on this invention:
The first object of the present invention is an optical device generating a distinct image created by immaterial luminous points detached from their original source.
A second object consists in a device generating a group of luminous points leaning on no material support.
A third object consists in a device generating through optical effect an “intangible” ellipsoid detached of any support.
A fourth object consists in a device that can present an object under an “intangible” form within aforementioned ellipsoid.
A fifth object consists in adapting this device for an application in luminary;
A sixth object consists in offering an optical element able to generate a double “intangible” ellipsoid detached from any material support;
A seventh object consists in offering an optical process able to generate an “immaterial” ellipsoid detached from any support under a wider vision angle;
An eight object is a device integrated in an independent machine, but that can be part of a wall of images constituted by the junction of several machines
A ninth object allows the ellipsoid to be a sphere;
A tenth object allows the ellipsoid to be a cylinder, or a cone;
An eleventh object allows the ellipsoid to have any shape (be it a cube, a pyramid); the form being generated by anisotropic deformation of optical plan;
A twelfth object allows the ellipsoid to be detached or not from generating support

### BRIEF DESCRIPTION OF THE DRAWINGS

Actual invention will be better understood thanks to the following descriptions and patterns

FIG. 1 represents a face view of one embodiment of the invention;

FIG. 2 represents a side view of one embodiment of the invention;

FIG. 3 represents a side view of one embodiment of the invention;

FIG. 4 represents a side view of the principle of one embodiment of the invention;

FIGS. 5 and 6 illustrate one embodiment of the invention and its way of functioning;

FIG. 7 also represents the one embodiment of invention and its way of functioning under a different angle;

FIG. 8 represents a variant of one embodiment of the invention;

FIGS. 9, 10, 11 and 12 represent a side view of a way of functioning of one embodiment of the invention.

FIGS. 13, 14 and 15 illustrate the principle of limit refraction.

FIG. 16 illustrates the general case of any form.

FIG. 17 represents a side view of the device when it generates a double intangible sphere.

### DETAILED DESCRIPTION

One embodiment of the present invention is an optical element having in three microstructured sheets with concentric grades forming refractive microprisms; the third sheet is or isn't microstructured depending on if generation of a simple or a double ellipsoid is desired.

One embodiment of the present invention is based on 2 optical principles: the principle of limit refraction angle inducted by a prism as a function of the observation angle and the principle of producing intangible real sources by having refracted beams crossing each other. The creation of an intangible form (sphere, cylinder, cone . . . ) is based on both principles, while the projection of the object within this form is essentially based on the second one.

The optical element of one embodiment of the present invention provides in three microstructured flat Fresnel lenses, joined or quasi joined and made in a material of high level light-transmission, each consisting in microprisms disposed in concentric spires. Microstructured zones are within the sandwich constituted by two thin microstructured sheets of the first optical element; the microstructured face of the third sheet being turned toward the side of this optical element. The presentation of information (objects, video . . . ) can then be done within a sphere but can also be done within another form

The same concept can apply to different specifically conceived systems such as (non exhaustive list):
Block display units
Luminary
Clock
Display devices: mobile phones, watches, dashboards, bathroom scales, domestic appliances . . .

By integrating different elements such as (non exhaustive list):
Colour filters
Sources of light (diodes, fluorescent neons . . . )
Display (electroluminescent, plasma, LCD, OLED . . . )
Two-way mirrors
Fluid elements
Light variators, colour variators

The process of one embodiment of the present invention is characterized under the principle of the invention by an optical device composed with two optical units 25 and 26: the first unit 25 is made with two microstructured Fresnel lenses 1a and 1b, whose scored faces are facing each other so that the respective tips of different scores are approximately facing each other. The second optical set 26 is made with a Fresnel lens 1c, presenting its scored face toward the first optical set 25. The optical set 1 generates the three-dimensional image of an “intangible” form 2 (sphere, ellipsoid, cone, cylinder) that doesn't lean on any support. This form 2 can be detached 6(d) from device 1 and will be visible by an observer 7.

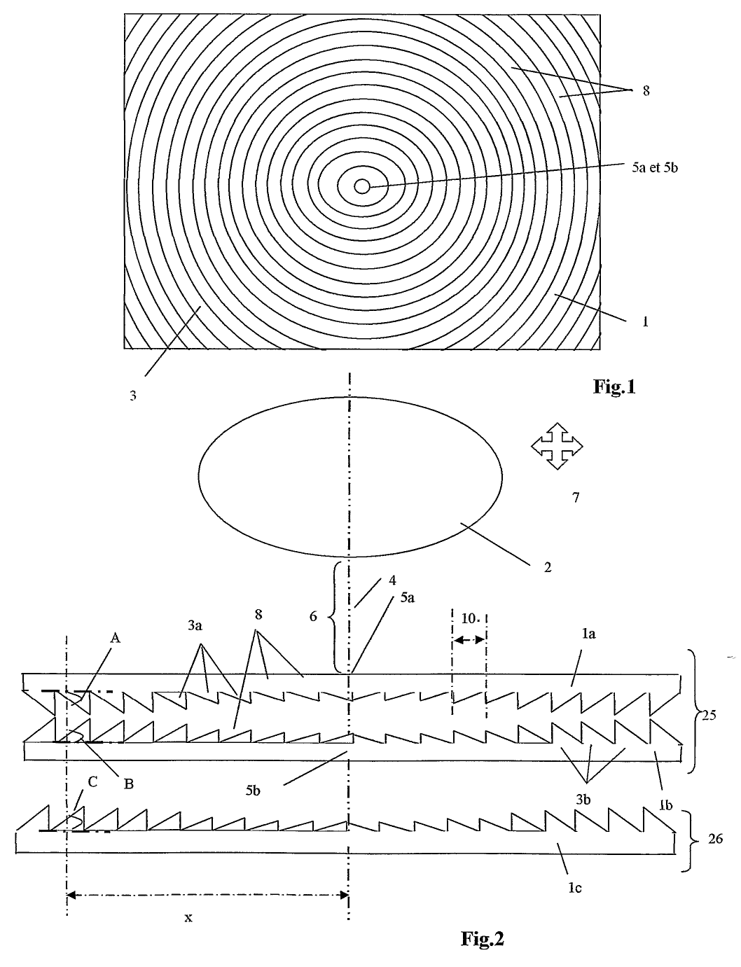

One embodiment of the present invention is characterized by the fact that 1a and 1b sheets are Fresnel lenses that are by definition made from micro prisms 8 organized in spires 3 (FIG. 1, above view) 3a and 3b (FIG. 2, section view) and organized in concentric circles of respective centres 5a and 5b. An alternatice embodiment of the invention provides a specific mode of slope variation A(x) and B(x) of lenses 1a and 1b micro prisms 8 as a function of their distance ‘x’ to the centre 5a and 5b to generate an “intangible” form 2 detached from any support. Depending on whether we generate a simple or double ellipsoid 2 the sheet 1c is either a Fresnel lens type 1a or 1b or a single sheet without microstructure.

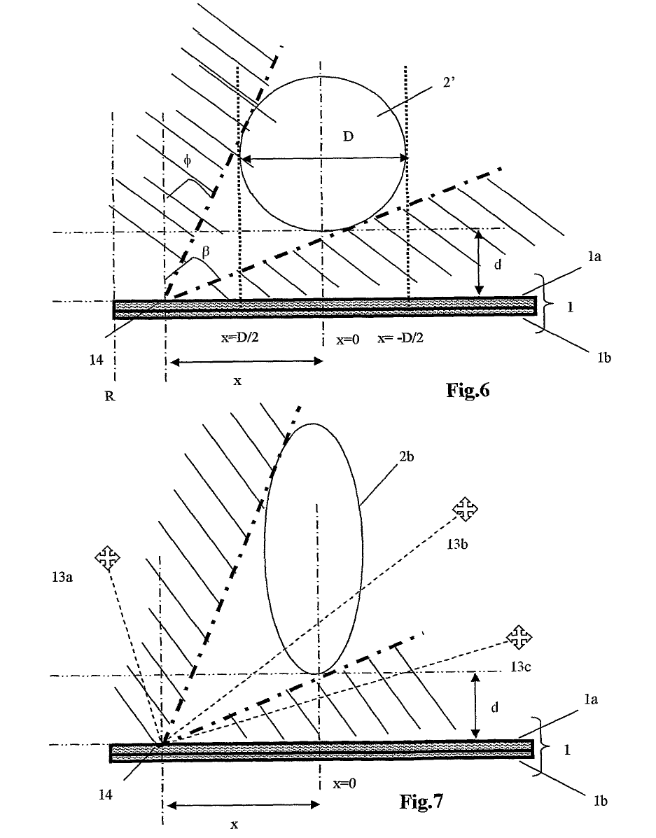

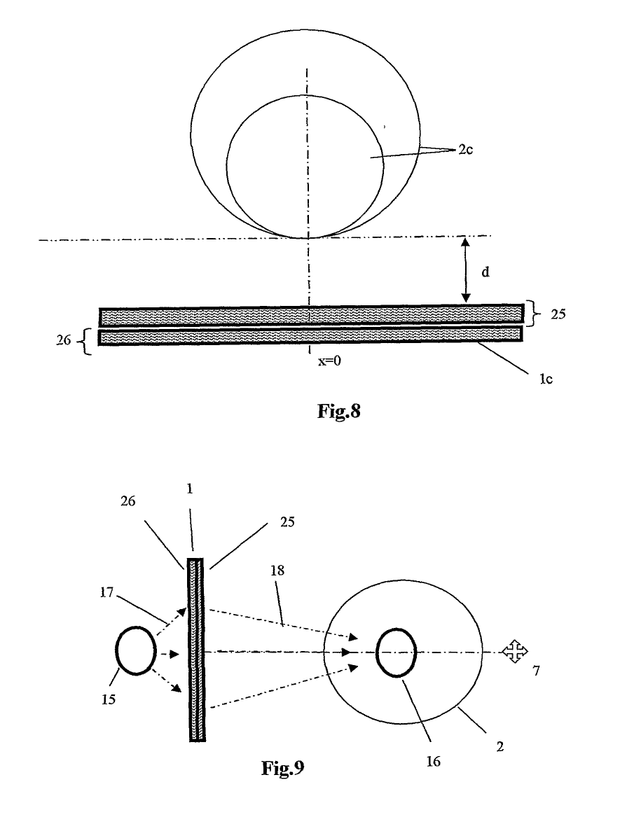

One embodiment of the present invention is characterized by the fact that optical device 1 generates optically translucent or opaque zones depending on the observation angle; the repartition of these zones is presented (for the specific case of a sphere) on FIGS. 4, 5 and 6.

For an observer 7 the surrounding of the sphere 2 is an opaque zone (whitish aspect if the material of the doublet is uncoloured); the ellipsoid is translucent; hence observers 11a,b,c,d,e (FIG. 4) watching a quasi punctual zone 14 of the surface of doublet 1 (side lens 1a) see this zone under an aspect that depends on their observation angle. According to the figure observers 11a and 11e see an opaque zone 14 (whitish); 11c observer see a translucent zone 14; observers 11b and 11d see a zone 14 between translucent and opaque.

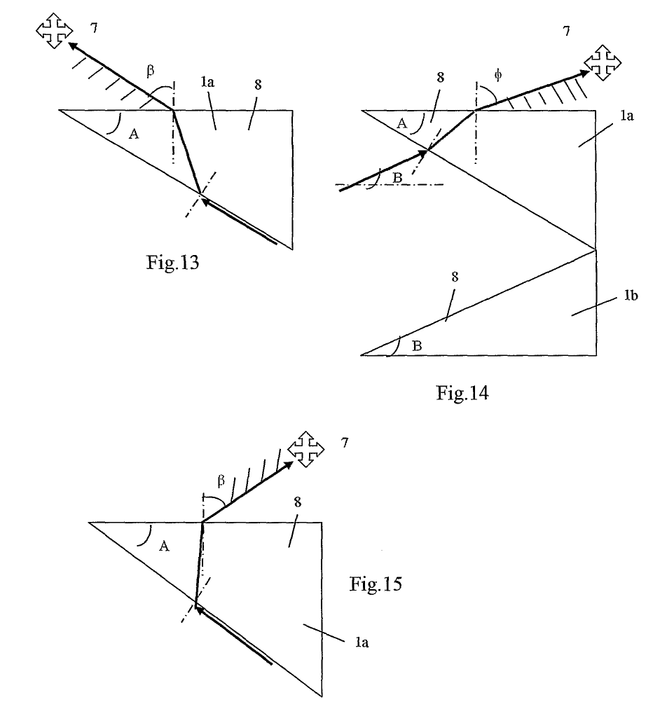

The variation in the level of opacity as a function of observation angle is generated using the optical phenomenon of refraction limit angle (FIGS. 13, 14, 15). The transition from a translucent state to an opaque one is seen when observer 7 watches toward a direction such as the passage of light beams through the prisms is not possible anymore. Any observation angle aiming at zone 14 and belonging to hatched zone (FIGS. 4, 5, 6 and 7) corresponds to an opaque vision of zone 14. Conversely any observation angle aiming at zone 14 and not belonging to the zone (FIGS. 4, 5, 6 and 7) corresponds to a translucent vision of zone 14.

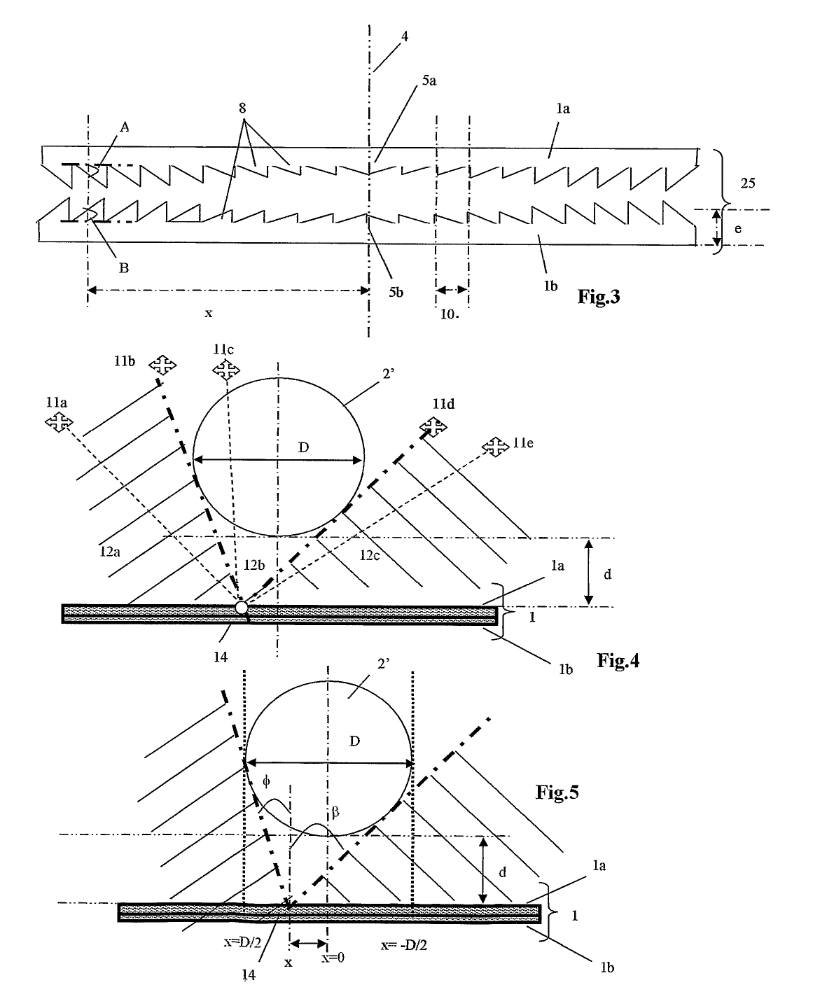

Here (FIGS. 4, 5 and 6) the process allows to generate an “intangible” form 2 detached from any support. On FIG. 3 we can see a section view of the doublet in its centre. The stride p is the length of a spire and 1/p represents the number of spires per millimetre. Every spire is characterized by an angle A(x) for lens 1a & B(x) for lens 1b as a function of distance x, where x is the distance between microprism 8 and centres 5a and 5b of lenses 1a and 1b.

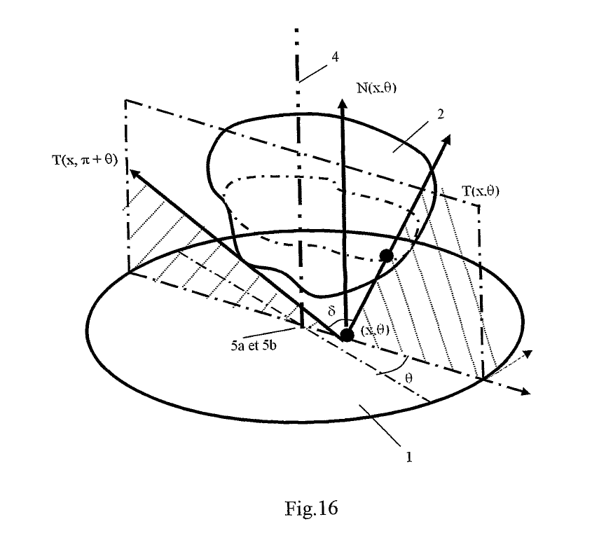

Based on FIGS. 5 and 6 we calculate angles β and φ according to the distance ‘x’ in the centre. We illustrated the particular case of a sphere. We have ‘d’ (detachment 6) and ‘r’ (radius of the sphere) as parameters 5 (d=2r) and we calculate β and φ by using laws of trigonometry. β and φ are only related to ‘x’ because the sphere is in a symmetry of revolution with the optical axis 4 of doublet. In the general case of an unspecified form 2, β and φ are calculated by the intersection of the tangent T(x,θ) to the section of form 2 with the perpendicular N(x,θ) to the plan of optical device 1 (FIG. 16). θ is the polar coordinate of the section T(x,θ) of axis 4.

If we pose n=lenses 1a and 1b refraction index (index of the air=1) we have for a sphere:

In Z1 zone (FIG. 5) (X between 0 and R), angle A(X) of lens 1a obeys the equation:

A(X)=arc sin(1/n)−arc sin(sin β/n); Angle B(X) of lens 1b obeys the equation: (1)

B(X)=ar cos(n sin r)−A(X) with r=arc sin(sin φ/n)−A(X). (2)

These equations satisfy the constraints illustrated on the diagrams of FIGS. 13 and 14:

On FIG. 13 angle A(X) is such as any observer 7 looking at the prism under an observation angle higher than the exit angle β(X) of the limit beam cannot see any beam refracted by prism 8 of lens 1a. According to FIG. 14 angle B(X) is such as any observer 7 looking under an angle higher than exit angle φ(X) cannot see any beam refracted by prism 8 of lens 1a.

In Z2 zone (FIG. 6) (X between R and R), angle A(X) obeys the equation:

A(X)=arc sin(1/n)+arc sin(sin β/n); (3)

Angle B(X) obeys the equation: (4) B(X)=ar cos(n sin r)−A(X) with r=arc sin(sin φ/n)−A(X). R is the radius of lenses 1a and 1b and N the refraction index of lenses 1a and 1b.

These equations satisfy the constraints illustrated on the diagrams of FIGS. 14 and 15:

On FIG. 15, angle A(X) is such as any observer 7 looking at the prism under an observation angle lower than the exit angle β(x) of the limit beam cannot see any beam refracted by prism 8 of lens 1a. According to FIG. 14, angle B(X) is such as any observer looking under an angle higher than exit angle φ(x) cannot see any beam refracted by prism 8 of lens 1a.

We take as an example Fresnel lenses with following characteristics:

Material: Acryglas LDC

Refraction index: 1.3

Here is an approximate formula allowing to determinate A(X) and B(X) according to X:

Distance of detachment 6 of the sphere: 15 cm

Radius of the sphere: 10 cm

For 0<X<10 cm approximation with 3-order least squares:

B(X)=0.004X³−0.0017X²−1.6463 X+76.566;

A(X)=−0.0023x³+0.0322 X²+1.694X+32.3469,

First-order:

A(X)=1.80 X+32.27

B(X)=−1.28x+75.72

For 10 cm<X<30 cm approximation with 3-order least squares:

A(X)=−0.0236 X²+2.272 X+29.8831

B(X)=−0.0006 X³+0.05 X²−1.82 X+76.82

First-order:

A(X)=1.42x+36.88

B(X)=−0.37x+66.45

(X is in cm, A(X) and B(X) in degrees)

To know A(N) and B(N) (where n=number of spire) we pose x=n*p+u−p/2; where ‘u’ is the radius of lenses 1a and 1b central micro hemisphere; ‘p’ the stride. We deduce A(N) and B(N) (where n is the number of the spire beginning from the centre with n=1).

Number of spires per mm: 1/0.508.

For a double sphere angle C (X) of lens 1c prism D;

We have C(X)=A(X) or C(X)=B(X).

For a simple sphere C(X)=constant; the aforementioned constant can be equal to zero.

We can write general equations of slopes A(X) and B(X) under the form of third-degree polynomials type ax³+bx²+cx+D where a, b, c and d are functions of β(X) and φ(X) satisfying zones constraints described by equations (1), (2), (3) and (4) and where C(X) is a constant, possibly equal to zero.

We take as a second example the case of a sphere not detached from generating support; that is to say here d=0.

In this case, we can estimate in first approximation that the angle of prisms A(X) and B(X) both increase as a function of the distance to the lens centre C according to the same linear function type: y=a (n−1)f+p (with “p” representing the initial angle of the first prism in degrees, “n” the number of the spire, “f” the stride between the spires in mm and “a” a constant in degrees per mm representing the variation rate of angle y).

We have A(X)=B(X)=C(X)

We check the optical possibility to generate an “intangible” sphere (detachment d=0) by taking following characteristics for lenses 1a and 1b (n between 1 and 190, higher angle quasi constant) Focal distance: 224 mm; Conjugate point: infinite; Conjugate plan: 224 mm. For approximate numerical values: p=2.7 degrees, f=0.508 mm, a=0.413 degrés/mm.

This result is more largely observed for numerical values belonging to following intervals:
Focal distances and conjugate plans ranging from 50 to 700 mm
Variable strides between 0.625 and 0.708 mm,
Conjugate points between 10.9 and infinite.

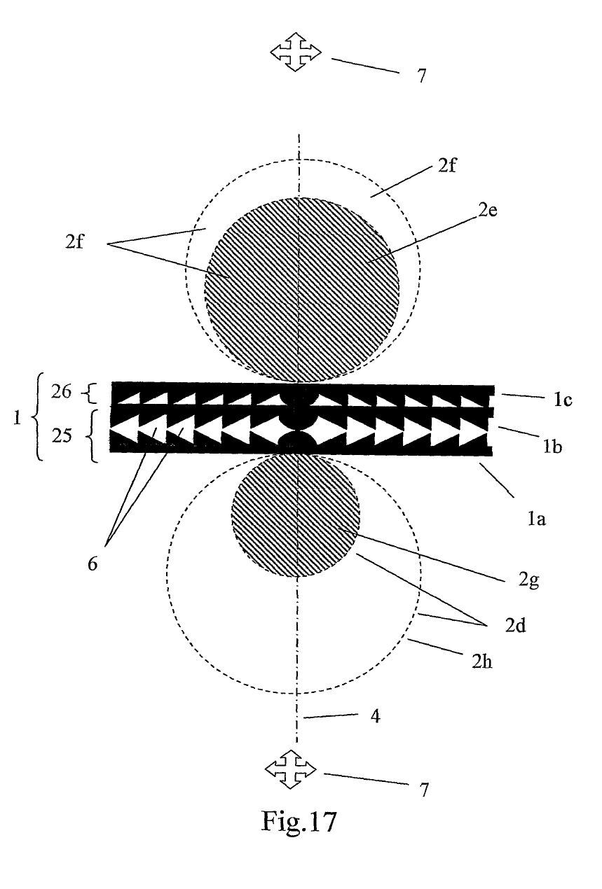

Lenses 1a and 1b form a first optical unit 25, to which is added a lens 1a or 1b with optical properties similar to optical unit 1 lenses 1a & 1b. This set forms a second optical unit 26. The spires of this associated set are turned toward the side of optical unit 1, as is illustrated on FIG. 17. It appears that the addition of a third lens type 1a or 1b (FIG. 17) makes it possible to generate two double spheres 2c and 2d visible on each face of the formed optical unit 25. Double spheres 2c and 2d each includes two spheres overlapped in each other (2f and 2e for double sphere 2c and 2h and 2g the double sphere 2d).

One embodiment of the present invention is globally characterized by a doublet of Fresnel lenses 1a and 1b of special manufacture ensuring that the equations of slope variation A(X) and B(X) of lenses 1a and 1b prisms can be expressed through approximation of least squares by 4 polynomials where A(X) and B(X) satisfy equations (1) (2) (3) & (4) for the particular case of a sphere.

β(x,θ) and φ(x,θ) can be written in a more general form in the case of an unspecified “intangible” form 2 (as is illustrated on FIG. 16):
1) β and φ are determined by intersection of the tangent to the section T(x,θ) of form 2 with the normal N(x,θ) to plan of optical device 1 (FIG. 16). θ is the polar coordinate of the section T(x,θ) of axis 4.
2) β(x,θ) and φ(x,θ) represent a function of distribution of the cone of vision Δ
3) According to the type of the “intangible” form 2 generated, we deduce a zoning of Z1 and Z2 zones; a Z1 zone includes constraints illustrated on FIGS. 13 and 14, hence equations (1) and (2), while a Z2 zone includes constraints illustrated on FIGS. 14 and 15, hence equations (3) and (4).

One embodiment of the present invention makes it possible to generate an “intangible” ellipsoid leaning on no support; the aforementioned ellipsoid will be in a particular case a sphere or more generally an ellipsoid (cf. FIG. 7). The principle making it possible to generate an unspecified “intangible” ellipsoid is the same as previously illustrated for a sphere; or more generally according to stages 1 to 4; zone 14 (FIG. 7) of optical unit 25 appears translucent or opaque according to observation angle: observers 13a and 13c see an opaque zone 14, while observer 13b sees a translucent zone 14. The principle of one embodiment of the present invention makes it possible to generate various forms like spheres, cylinders, wafers (non exhaustive list) and also though deformations (see hereafter) elements which are not automatically objects with a symmetry of revolution: cubic, pyramid.

In the particular case where the ellipsoid is a cylinder whose axis of revolution is confused with the optical axis of optical unit 25 we have

For 0<X<C/2

β(X)=arc tan {(x+c/2)/d} and β(X)=arc tan {(C/2−X)/d};

A(X)=arc sin(1/n)−arc sin {sin β(X)/n};

B(X)=ar cos(n sin r)−A(X) with r=arc sin {sin(φ(X)/n)}−A(X)

For C/2<X<X

φ(X)=arc tan {(x+c/2)/d} and β(X)=arc tan {(X−C/2)/(d+h)};

A(X)=arc sin(1/n)+arc sin {sin β(X)/n};

B(X)=ar cos(n sin r)−A(X) with r=arc sin {sin(φ(X)/n)}−A(X);

Where d=distance between the base of the cylinder and the generating support; h=height of the cylinder; c/2=radius of the cylinder; n=refraction index of optical elements which constitute the doublet 1; A(X) and B(X) angles of lenses 1a and 1b microprisms 8; X distance from a microprism to the optical centre; X radius of optics 1a and 1b.

In the particular case where the ellipsoid is a cone whose axis of revolution is confused with the optical axis of optical unit 25 we have:

For 0<X<C/2

φ(X)=arc tan {(x+c/2)/d} and β(X)=arc tan {(C/2−X)/d};

A(X)=arc sin(1/n)−arc sin {sin β(X)/n};

B(X)=ar cos(n sin r)−A(X) with r=arc sin {sin(φ(X)/n)}−A(X);

For C/2<X<P

φ(X)=arc tan {(x+c/2)/d} and β(X)=arc tan {(X−C/2)/(D)};

A(X)=arc sin(1/n)+arc sin {sin β(X)/n};

B(X)=ar cos(n sin r)−A(X) with r=arc sin {sin(φ(X)/n)}−A(X);

For P<X<X

φ(X)=arc tan {(x+c/2)/d} and β(X)=arc tan {X(d+h)};

A(X)=arc sin(1/n)+arc sin {sin β(X)/n};

B(X)=ar cos(n sin r)−A(X) with r=arc sin {sin(φ(X)/n)}−A(X);

Where P=(d+h)*k/(2h), d=distance between the base of the cone and generating support; h=height of the cone; c/2=radius of the circular base of cone; n=refraction index of the elements constituting doublet 1; A(X) and B(X) angles of lenses 1a and 1b microprisms 8; X distance from a microprism to the optical centre; X the radius of optics 1a and 1b.

According to a particular mode of realization of the invention, optical device 1 will be able to undergo a deformation; for example a stretching according to a direction of lenses 1a, 1b and 1c plan to generate an asymmetrical form 2 like an ovoid, or angular shapes such as cubes or pyramids (concentric spires 3 organized in squares or concentric triangles)

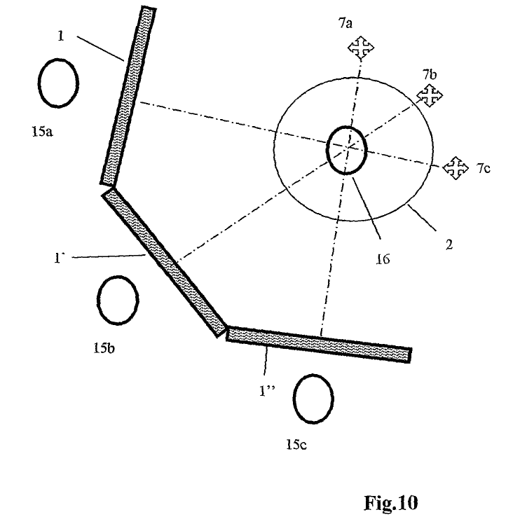

According to a particular mode of execution illustrated on FIG. 10, we associate several optical devices 1 (here 3) to generate an “intangible” sphere 2 “floating” in the air: each device 1, 1′ and 1″ generates a sphere so that they are superimposed to form a sphere or a double ‘intangible’ sphere 2.

Based on FIG. 9, one embodiment of the present invention makes it possible to project the image 16 of a real object 15 within sphere 2. Device 1 refracts beams 17 emitted by source 15 in light beams 18 that form real image 16, leaning on no support and visible by an observer 7.

The process can be applied within the framework of what was exposed FIG. 10: sources 15a, 15b and 15c represent several sources whose respective images formed by devices 1, 1′ and 1″ are superimposed in a single and coherent image 16.

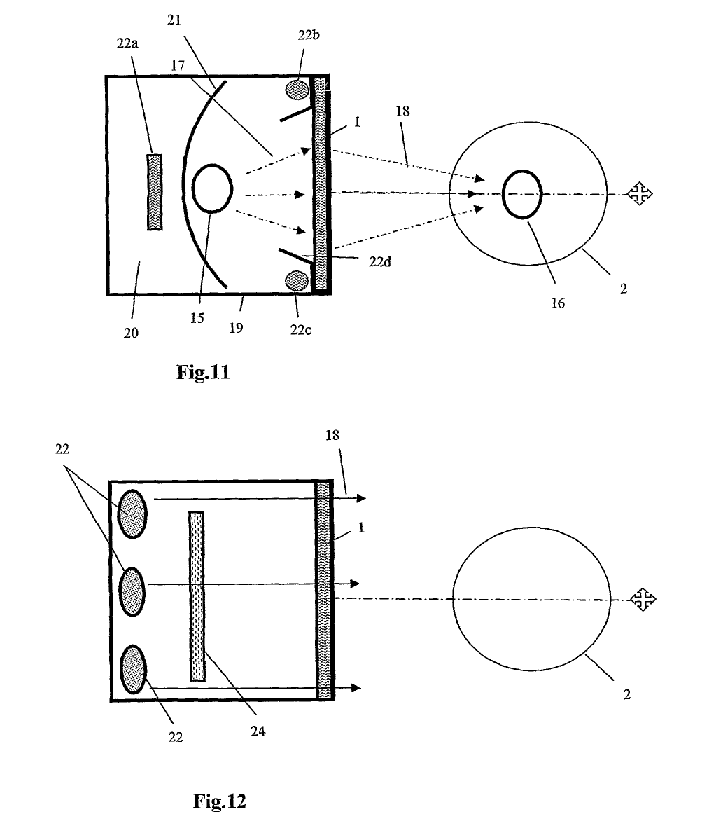

One embodiment of the present invention applies e.g. to the presentation of object (cf. FIG. 11) and to luminaries (cf. FIG. 12) (non exhaustive list)

On FIG. 11 is presented a device presenting objects in “intangible” form within an “intangible” sphere 2. The device consists of a monolithic case 19 characterized by the fact that it includes two zones: a “back lighting” zone and an “object” zone. The zones are separated by a curved semi translucent sheet 21 sanded and/or diffusing (anti-reflecting). The object is laid out in the hollow of sheet 21 and possibly on a support linked to an engine located in the “lighting” zone. Sources of light 22b and 22c light object 15 and are masked above by bent masks 22d which can also serve as light reflectors.

A 22a light source can be installed in the back “lighting” zone of sheet 21 to illuminate the back of object 15, making it possible to accentuate the sustentation effect of “intangible” object 16. The optical device 1 is placed at a correct distance from object 15 to form an image of it within the sphere or double sphere 2. This device more particularly applies to the presentation of objects and could be integrated in a totem or any presentation device designed for advertising or sale: display unit, box embedded in ground . . . . Generally, one embodiment of the present invention could be integrated in elements used for the presentation of objects or videos within display units, terminals, walls, false ceilings and totems (non-exhaustive list).

On FIG. 12 is presented a luminary characterized by the fact that optical device 1 is associated to a diffusing filter 24 and a source of light 22.

The aforementioned filter could be coloured or colourless. The source of light will be characterized by one or several elements such as diodes, neons or any other device producing light, it could even be coupled with a system of color modulation. To accentuate the detachment of the “intangible” form 2 we can integrate a filter 24 specifically geometrically studied to allow the light resulting from source 12 to directly pass through optical device 1 (beams 18). Under an adequate shape the filter makes it possible to maintain uniform luminosity between the periphery of optical device 1 and the edge of the “intangible” form 2. This geometry is connected to the distances between the filter 24, the source 22 and the doublet 1. In order to obtain a perfectly homogeneous “intangible” form 2 we will choose a filter such as its image generated by optical device 1 entirety covers the surface of “intangible” form 2 for any observation angle.

According to various modes of realization, we will be for example able to associate fluid elements between source 22 and filter 24 and or between filter 24 and optical device 1. The aforementioned fluid could be put moving, illuminated by secondary sources of light, mixed with diffusing and or particulate substances. The association of such elements will be able to generate a deterioration of the sphere according to the undulations of the fluid. To attenuate the concentration of sun emitted beams in the centre of the luminary we place a diffusing filter between optical device 1 and its color filter. The diffusing or dispersive filter is characterized by a dense microstructure (scale of “defects” ranging between 0.1 mm and 0.5 mm) whose role is to spread out incidental beams. A sheet including a network of microballs or micro hemispheres could be employed (non exhaustive modification list).

Optical device 1 could be integrated within different systems: watches, mobile phone screens, computers, dashboards, scales, viewers, furniture elements (coffee tables, pub bars), display units, clothing, toys etc. (non exhaustive application list).

1-10. (canceled)

11. An optical device, the optical device comprising comprising:
A first Fresnel lens;
A second Fresnel lens;
A third Fresnel lens;
Each of said first second and third Fresnel lenses being configured from a material having a high level light transmission factor and with concentric scores one a side forming prisms, each said prism having a slope determined by its position relative to the center of each said Fresnel lens and angle θ;
a first optical unit comprising said first and second Fresnel lenses and wherein said first and second Fresnel lenses are disposed such that said scores of said first Fresnel lens are disposed opposite to said scores of said second lense;
a second optical unit comprising said third Fresnel lens, said second optical unit being disposed such that said scores of said third Fresnel lens are disposed proximate to said first optical unit; and
said first and second optical units being configured to project an intangible ellipsoid.

12. The optical device according to claim 11 wherein said ellipsoid is selected from the group of ellipsoids consisting of spheres, cones, or cylinders.

13. The optical device according to claim 11 wherein:
said slopes of said prisms of said first Fresnel lenses are A(x,θ) where A(x,θ)=sin⁻¹(1/n)−sin⁻¹(sin β/n);
said slopes of said prisms of said second Fresnel lenses are B(x,θ) where B(x,θ)=cos⁻¹(n sin(sin⁻¹(sin φ/n))−A(x,θ);
and where angles β(x,θ) and φ(x,θ) are defined depending based on whether said angles belong to a first zone Z1 or a second zone Z2, ‘x’ being the distance to the axis of said ellipsoid and θ being the polar angle.

14. The optical device according to claim 1 wherein said intangible ellipsoid is a double intangible sphere wherein said first second and third Fresnel lenses present a surface on which the angles of said prisms linearly increase from a centre to extremities of respective said first, second and third lenses.

15. The optical device according to claim 1 wherein said intangible ellipsoid is a double intangible sphere wherein said first second and third Fresnel lenses present focal distance and conjugate plans between 50 and 700 mm, stride between scores between 0.125 and 0.708 mm (0.508 as favourite value); conjugate point between 10.9 mm and infinite.

16. The optical device according to claim 1 wherein said intangible ellipsoid is a double intangible sphere wherein said first second and third Fresnel lenses each have a first prism angle of about approximately 2.7 degrees, a distance between scores of about approximately 0.508 mm and a linear angle variation slope of about approximately 0.413 degrees per millimetre.

17. The optical device according to claim 1 wherein said ellipsoid is a cylinder; a slope of said prisms of said first Fresnel lens obey a function A(X) and a slope of said prisms of said second Fresnel lens obey a function B(X) where for 0<x<c/2: φ(x)=tan⁻¹{(x+c/2)/d} and β(x)=tan⁻¹{(c/2−x)/d}; A(x)=sin⁻¹(1/n)−sin⁻¹{sin β(x)/n}; B(x)=cos⁻¹(n sin r)−A(x)avec r=sin⁻¹{sin(φ(x)/n)}−A(x); For c/2<x<X: φ(x)=tan⁻¹{(x+c/2)/d} and β(x)=tan⁻¹{(x−c/2)/(d+h)}; A(x)=sin⁻¹(1/n)+sin⁻¹{sin β(x)/n}; B(x)=cos⁻¹(n sin r)−A(x)avec r=sin⁻¹{sin(φ(x)/n)}−A(x); where d=a distance between base of said cylinder and generating support; h=height of said cylinder; c/2 is the radius of said cylinder ; n is the refraction index of optical units; and where C(x) is a constant.

18. The optical device according to claim 17 wherein said cylinder is a double cylinder and said C(x)=A(x) or B(x).

19. The optical device according to claim 17 wherein said cylinder is a single cylinder and said C(X) equal to zero.

20. The optical device according to claim 13 wherein said intangible ellipsoid is a single intangible sphere and A(x) and B(x) have the form of 3rd-type polynomials type ax3+bx2+cx+d, where a,b,c and d are functions of β(x) and φ(x) obeying to zone constraints, and where C(x) is a constant, eventually equal to zero.

21. The optical device according to claim 1 further comprising a compartment to place an object, back and front lighting systems, a curve diffusing element permitting the light emitted by said back lighting system partially pass through and masks configured to function as a light refractor toward said object

22. The optical device according to claim 1 further comprising a diffusing light filter of a specific geometry and a light source, wherein light from said light source is permitted to go directly to said first and second optical units by said diffusing light filter.

23. The optical device according to claim 22 wherein said diffusing light filter is a dispersive microstructured filter comprising a network of microballs whereby beam focalization phenomenon are attenuated.

24. The optical device according to claim 22 further comprising a fluid disposed between said light source and said diffusing filter.

25. The optical device according to claim 22 further comprising a fluid disposed between said diffusing filter and said first and second optical units.
